(19) United States
(12) Patent Application Publication
(10) Pub. No.: US 2025/0003506 A1
(43) Pub. Date: Jan. 2, 2025

(54) AN IMPROVED CONICAL ELEMENT FOR GAS PASSAGE IN MULTI-STAGE GAS TAPS

(71) Applicants: Gökhan Turhan, Istanbul (TR); TURAS GAZ ARMATÜRLERI SAN. VE TIC. A.S., Istanbul (TR)

(72) Inventor: Gökhan TURHAN, Istanbul (TR)

(21) Appl. No.: 18/687,972

(22) PCT Filed: Nov. 29, 2021
(86) PCT No.: PCT/TR2021/051308

§ 371 Date: Feb. 29, 2024

(30) Foreign Application Priority Data
Nov. 22, 2021 (TR) 2021/018212

(51) Int. Cl. F16K 5/02; F16K 5/22; F23K 5/00

(52) U.S. Cl. CPC F16K 5/0207; F16K 5/222; F23K 5/007

(57) ABSTRACT

The present invention relates to a gas tap (1) for domestic and industrial gas cookers, and it generally consists of assembling a body (1.3) having a gas inlet (1.3.1) and one or two gas outlets (1.3.2); a shaft (1.1); a cover (1.2); a conical element (1.4) and other parts. According to said gas tap (1), when the user rotates the button, the shaft (1) therein rotates such that the channelled conical element rotates in each rotation angle, resulting in a gas flow at different flow rates. Thanks to the channelled conical element (1) of the invention, a step gas tap is provided, which provides a combined solution to the problems of the absence of ideal flow rate decrease, instability in the flame, the formation of unstable flames due to the formation of unwanted peaks in the flow values, and the low number of products.

### TECHNICAL FIELD

The invention relates to a conical element contained in gas taps that provides a gas flow in domestic or industrial gas cookers. A channel contained in the conical element allows a level of the flame, which will occur when a user rotates a shaft clockwise or counter clockwise, to be at 9 stages or preferably more than 9 stages. In addition, the conical element comprises oil channels in order to provide stability in the decrease of the flow rates forming the flame.

### BACKGROUND OF THE INVENTION

In gas taps, when the user rotates the button, the shaft therein rotates simultaneously in the conical element, resulting in a gas flow at different flow rates at each rotation angle. Gas taps with a stage are used in the sector, for which patent applications are provided in the literature.

Copreci has made an application with the number CN205260904 in 2015. In this application, a gas tap for adjusting a flame level by a conical element with a channel is disclosed. When the figures in the document are examined, the stage decrease in the flames is provided by a flow passage channel, which is indicated by 24. According to the operation of the gas tap, the conical element rotates inside a body. As the conical element rotates in the body, a friction force occurs therebetween. In order to minimize this friction, surfaces of the conical element are lubricated. However, this oil accumulates in the flow passage channel over time. In this case, a decrease in the flow rate cannot be achieved in an ideal way, creating a technical problem such as instability in the flames. Moreover, when the flow rate decreases according to the angle, the flow rate values peak and decrease. In this case, it is an undesirable technical problem.

In order to solve the above-mentioned technical problem, we, as Turaş Gaz Armatürleri Sanayi Ticaret Anonim Şirketi, made an application with the number TR 2017 17065 in 2017. Said application relates to a 9-stage gas tap that provides flow rate transitions. The flame stage to be formed by the conical element that provides the flow passages is provided by the holes therein. Conical element comprises a full through hole, a minimum through hole and holes with 7 different diameters. The gas tap disclosed in the application allows an ideal way for the decrease in the flow rates. FIG. 19, FIG. 20 and FIG. 21 presented in the application show the ideal decrease in flow rates. For the production of holes of different diameters in the conical element, firstly, a rough drilling is performed by a fork drill. Then, since the diameters of the holes are different from each other, holes are drilled using 7 different tools. In order to eliminate the use of 7 different tools, a stepped or tapered tool can be used to obtain the holes. TR 2019 00506 and TR 2019 00508 are provided for the mentioned tools. Although these tools have eliminated the use of 7 different tools and shortened the production time, they operate at high speeds because the diameter of the holes is very small and sensitive. Operating at high speed results in low progress. In this case, desired high numbers in mass production cannot be provided, creating a technical problem such as low production.

The above-mentioned patent documents are provided in the literature. However, there is no application that provides a solution to all of the above-mentioned problems such as lack of ideal flow rate decrease, instability in the flame, undesired peaks in flow rates, and low number of products. The present invention provides a solution for said technical problems.

### OBJECT OF THE INVENTION

An object of the invention is to provide a stage gas tap which allows an ideal flow rate decrease by a channelled conical element.

Another object of the invention is to prevent the oil from accumulating in the main passage channel contained in the conical element, and to eliminate the oil clogging problem in the channel.

Another object of the invention is to provide a stage gas tap that can be produced in high quantities by reducing the production time.

A further object of the invention is to provide a gas tap comprising a channelled conical element which allows a linear curve in the angle-flow diagram.

### BRIEF DESCRIPTION OF THE DRAWINGS

FIG. 1 is a cross-sectional view of the stage gas tap according to the invention.

FIG. 2 is a side view of the channelled conical element according to the invention, in which the beginning of the main channel is indicated.

FIG. 3 is an E-E cross-sectional view of the conical element according to the invention.

FIG. 4 is a side view of the channelled conical element according to the invention, in which the end of the main channel is indicated.

FIG. 4a is a detailed view of the conical element according to the invention.

FIG. 5 is a side view of the perforated conical element according to the invention.

FIG. 6 is a side view of the channelled conical element according to the invention.

FIG. 7 is an angle-flow graph of the stage gas tap of the invention and the stage gas tap comprising the channelled conical element.

### REFERENCE NUMERALS

1. Gas Tap
   1.1. Shaft
   1.2. Cover
   1.3. Body
      1.3.1. Gas Inlet
      1.3.2. Gas Outlet
   1.4. Conical Element
      1.4.1. Maximum Burning Hole
      1.4.2. By-Pass Channel
      1.4.3. Main Channel
         1.4.3.1. Beginning of the Main Channel
         1.4.3.2. End of the Main Channel
      1.4.4. Oil Channel
         1.4.4.1. Oil Climbing Side
   1.5. Current Perforated Conical Element
      1.5.1. Hole
   1.6. Current Channelled Conical Element
      1.6.1. Main Channel
D1. Starting Depth
D2. Ending Depth
H. Height
β. Angle

### DETAILED DESCRIPTION OF THE INVENTION

The invention relates to gas taps (1) having an improved conical element with a channel designed to be used in domestic or industrial gas cookers. In general, it consists of assembling a body (1.3) having a gas inlet (1.3.1) and one or two gas outlets (1.3.2); a shaft (1.1); a cover (1.2); a conical element (1.4) and other parts. The operation of the stage gas taps is initiated by the user rotating the button clockwise or counter clockwise according to an angle determined on the cover or another element providing the stage. The conical element rotates with the rotation of the shaft (1.1) on which the button is attached. The conical element, which currently provides a stage transition, has a perforated pattern (1.5) or a channelled pattern (1.6). The conical element with a perforated pattern (1.5) is shown in FIG. 5, and the conical element with a channelled pattern (1.6) is shown in FIG. 6. According to the first angle value determined, the transition is provided through the maximum burning hole (1.4.1) in the conical element. In this case, the flame occurring in the burners is at the maximum level. The user rotates the button again in order to reduce the maximum flame. As the angle of rotation gradually increases, the flame level decreases. The stages are completed with the minimum transition in the last stage. There is a continuous transition in the by-pass channel (1.4.2) for the formation of the first flame, including maximum burning and minimum burning.

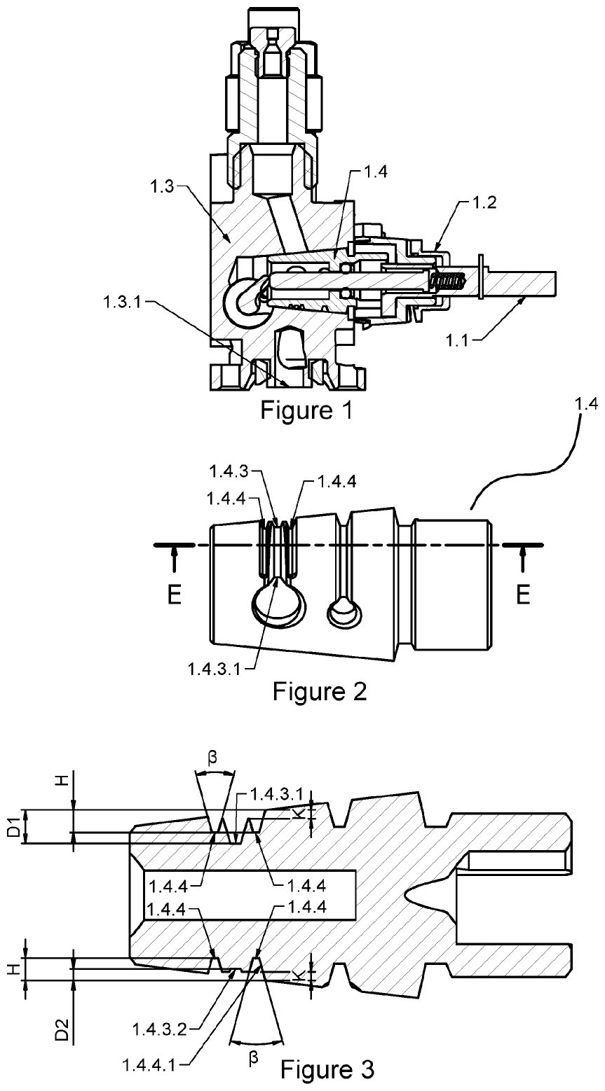

Operation of the stage gas tap (1), which comprises a perforated conical element (1.5), a channelled conical element (1.6) and a channelled conical element according to the invention (1.4), is the same as described above. The conical element is always positioned in the conical element housing located in the body (1.3), as shown in FIG. 1, due to the operation of the gas tap. Due to the movement of the conical element inside the body (1.3), friction occurs therebetween. In order to reduce this friction, oil is applied to the surface of the conical element. However, the oil applied over time fills the current main channel (1.6.1) and causes the channel to become clogged. Due to this clogging, the flow rate values do not become ideal. The dotted lines in the angle-flow rate graph in FIG. 7 refer to the stage gas tap with the current channelled conical element (1.6). Even if a gradual decrease is achieved with the current channelled conical element (1.6), the flow values decrease with a peak. The formation of these peaks creates instability in the flame, which is an undesirable technical problem in burners.

Another conical element used in stage gas taps currently used is the perforated conical element (1.5) with holes of different diameters. The perforated conical element (1.5) comprises gas passage holes (1.5.1) of 7 different diameters. The stages are formed by the passage of gas through holes of different diameters. A decrease in flow rate for this perforated conical element (1.5) is excellent and at an ideal level. However, the production numbers of the perforated conical element (1.5) are low. This is because a process for drilling holes (1.5.1) consists of more than one production process. First, rough holes are drilled by means of a fork drill. Then, 7 different tools or stage tools or conical tools are used to drill holes of different diameters. The small size of the holes requires a precise operation. The operation is performed at high speeds, with low feed. Thus, even if perfect burning graphics are obtained with the perforated conical elements used at the end of the operation, the number of products produced is low.

A combined solution to the above-mentioned problems such as lack of ideal flow rate decrease, instability in the flame, formation of unstable flame with the formation of unwanted peaks in flow values, and low number of products are provided by the stage gas tap (1) comprising the channelled conical element (1.4) according to the invention. The gas tap (1) according to the invention has not been provided neither in sector nor in literature.

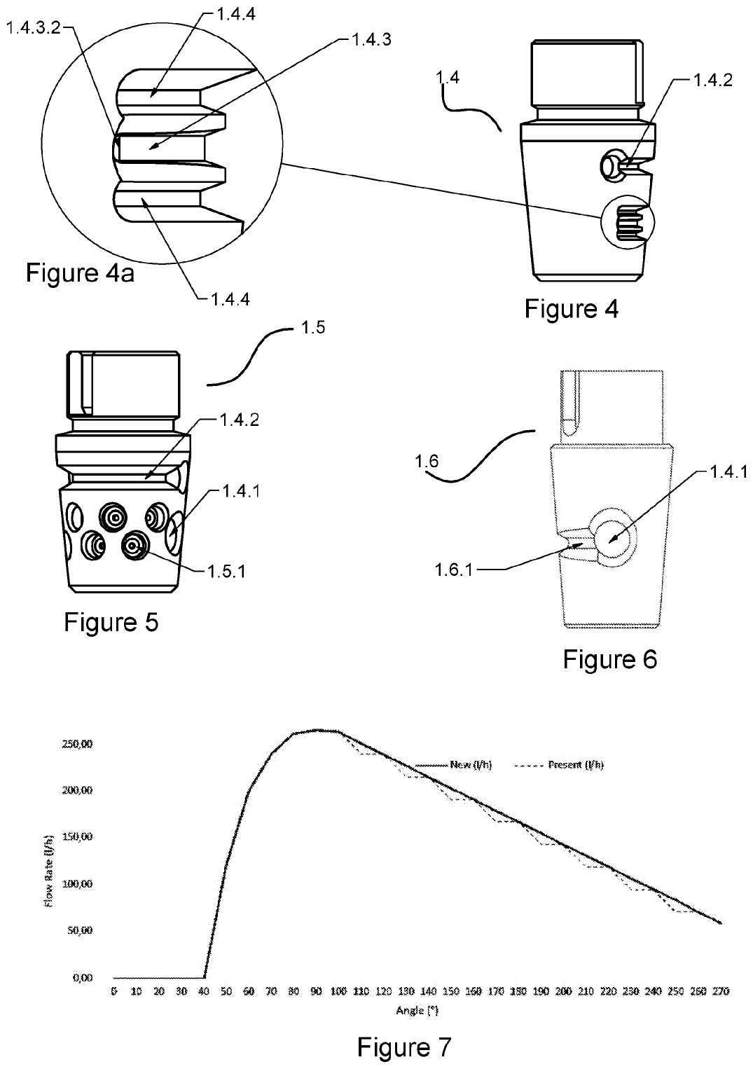

The above-mentioned problems are solved by the channelled conical element (1.4) according to the present invention. In FIG. 2, FIG. 3 and FIG. 4, an illustration of the channelled conical element (1.4) according to the invention is provided, while in FIG. 4a, a detailed image thereof is illustrated. In the channelled conical element (1.4) according to the invention, in order to solve the problem of oil clogging in the current main channel (1.6.1), two oil channels (1.4.4) are provided around the main channel (1.4.3) thereof. Said oil channels (1.4.4) surround the main channel (1.4.3) from the beginning (1.4.3.1) to the end (1.4.3.2) of the main channel (1.4.3). The bottom height (H) of the oil channels (1.4.4) is at least 1.4 mm from the surface of the conical element. The conical element (1.4) also comprises a climbing side (1.4.4.1) with an angle, β. The angle β is at least 30°. The oil applied to the surface of the conical element (1.4) first fills the oil channels (1.4.4), and the passage of oil into the main channel (1.4.3) is prevented due to the climbing side (1.4.4.1). Thus, a solution is provided to the oil accumulation problem that may occur in the main channel (1.4.3). In addition, the main channel is in a spiral form, decreasing in depth. The beginning depth (D1) of the main channel (1.4.3) is deeper than the ending depth (D2). That is, the depth of the main channel decreases from the beginning (1.4.3.1) to the end (1.4.3.2). There is a difference of at least 0.3 mm and at most 1.5 mm between the D1 depth and the D2 depth. A elevation height (K) has been added between the oil channels and main channel, so that the main channel (1.4.3) does not come into contact with the conical surface. Thus, oil transfer from the conical surface to the main channel is also prevented. The elevation height (K) of the oil channel is at least 0.20 mm from the surface of the conical element. With this design improvement made in the main channel and the addition of oil channels, unwanted peak transitions are prevented in the current flow rate transitions, as shown in FIG. 7. Flow rate transition in stage gas taps comprising the conical element with the improved main channel is ideal, as illustrated in FIG. 7.

1. A conical element comprised in gas taps with a multi-stage burning used in domestic or industrial cookers, characterized by comprising at least one main channel (1.4.3) decreasing in depth in a spiral form, at least one oil channel (1.4.4) surrounding the main channel (1.4.3), and an elevation height (K) which prevents oil passage into the main channel as a result of surface contact.

2. A gas tap (1) according to claim 1, characterized in that the main channel (1.4.3) for multi-stage gas passage, which is provided in the conical element (1.4), has a difference of at least 0.3 mm and at most 1.50 mm between depth D1 and depth D2.

3. A gas tap (1) according to claim 1, characterized in that the oil channel, which provides oil accumulation in the gas passage channel, preferably comprises an angled oil climbing side.

4. An oil climbing side according to claim 3, characterized in that the angle (β) thereof is at least 30°.

5. A gas tap (1) according to claim 1, characterized in that the elevation height (K), which prevents oil passage into the main channel as a result of surface contact, is at least 0.2 mm lower than the surface of the conical element.
